(19) United States
(12) Patent Application Publication
(10) Pub. No.: US 2008/0165233 A1
(43) Pub. Date: Jul. 10, 2008

(54) Ink stirrer for a large ink-jet printer

(75) Inventors: Hsien-Chang Lin, Hsi Chih City (TW); Yu-Ming Yang, Hsi Chih City (TW)

Correspondence Address: TROXELL LAW OFFICE PLLC, SUITE 1404, 5205 LEESBURG PIKE, FALLS CHURCH, VA, 22041, US

(73) Assignee: Great Computer Corporation

(21) Appl. No.: 11/650,580

(22) Filed: Jan. 8, 2007

(51) Int. Cl. B41J 2/175

(52) U.S. Cl. 347/86

(57) ABSTRACT

An ink stirrer for a large ink-jet printer is disclosed. The ink stirrer includes a spindle designed to be pivotally disposed within an ink cartridge, and at least one blade extending downward from the spindle. Furthermore, one said blade is provided with a bottom lump having a large mass that the blade may swing to and fro within the ink container and thereby stir the ink as a result of the reciprocating movement of the carriage during the printing process.

### FIELD OF THE INVENTION

The present invention relates to an ink stirrer for a large ink-jet printer and, more particularly, to an ink stirrer which may automatically and reliably stir ink as a result of the reciprocating movement of the ink cartridge during a printing process.

### BACKGROUND OF THE INVENTION

A large ink-jet printer typically includes a controllably reciprocating carriage on a sliding mechanism for ejecting ink onto a print medium. The reciprocating carriage is installed with plural print heads and ink cartridges supplying respective colors of ink to print heads. The print heads have respective bottom nozzles to eject differently colors of ink, and the ejected ink is quickly dried and cured onto the print medium by ultraviolet lights radiated from the ultraviolet generation devices disposed on sides of the carriage, in order to avoid the printed patterns or characters from being blurred by the carriage in motion.

When a large ink-jet printer prints an image on a print medium with a colored surface other than white, or on a print medium such as transparent resin film, white ink for white image or white background printing is required. However, the composition of white ink has a chemical property apt to result in sediments within the ink cartridge. Such sediments will clog the nozzle and bring a permanent damage to the print head.

One way to solve the problem is to shake the container before printing, and the shaking process must be operated manually. Another way is to equip the carriage with an electronic device for stirring the ink in the cartridge. However, it is found that problems can be encountered during the printing process, such as malfunctions of electronic devices, or installment of bulky electric devices into space-limited carriage.

Therefore, there is a need for an improved ink stirrer to overcome the shortcomings of the prior art.

### SUMMARY OF THE INVENTION

It is an object of the present invention to provide an ink stirrer which can automatically and reliably stir ink as a result of the reciprocating movement of the ink cartridge during the printing process.

To achieve the aforementioned object, the present invention provides an ink stirrer including a spindle designed to be pivotally disposed within an ink cartridge, and at least one blade extending downward from the spindle. Furthermore, one said blade is provided with a bottom lump having a large mass that the at least one blade can swing to and fro within the ink cartridge and thereby stir the ink as a result of the reciprocating movement of the ink cartridge.

Other objects, advantages and novel features of this invention will become more apparent from the following detailed description when taken in conjunction with the accompanying drawings.

### BRIEF DESCRIPTION OF THE DRAWINGS

FIG. 1 is a perspective view of a preferred embodiment of an ink stirrer in accordance with the present invention for use in a large ink-jet printer;

FIG. 2 is a perspective view showing the ink stirred of FIG. 1 to be pivotally disposed within an ink cartridge of the printer;

FIG. 3 is a perspective view showing a relationship in position between the ink stirrer and the ink cartridge according to the embodiment of FIG. 1; and

FIG. 4 is a perspective view showing the status of the ink stirrer of FIG. 1 stirring ink held in the ink cartridge.

### DETAILED DESCRIPTION OF THE PREFERRED EMBODIMENT

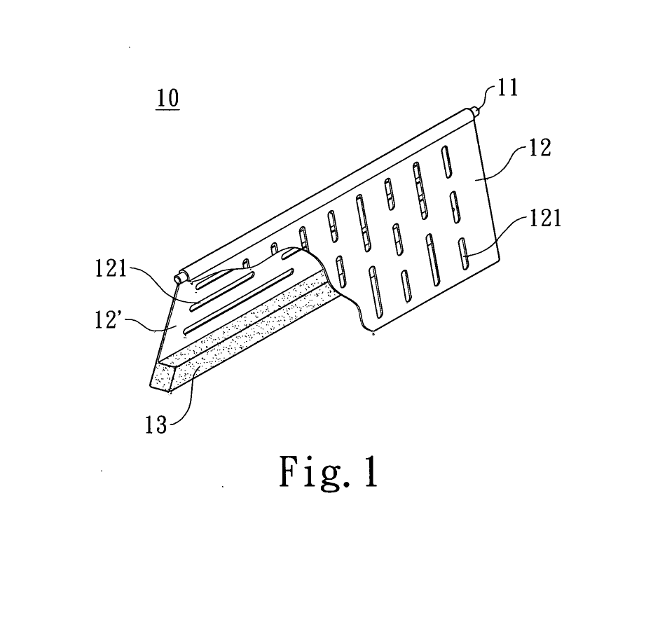

Referring to FIG. 1 there is shown a preferred embodiment of an ink stirrer 10 constructed in accordance with the present invention for use in a large ink-jet printer (not shown).

The ink stirrer 10 includes a spindle 11 and a pair of angularly spaced blades 12 and 12′ extending downward form the spindle 10. It is preferable that the spindle 10 is formed integrally with the blades 12 and 12′.

As shown in FIG. 1, each of the blades 12 and 12′ has lines of through-holes 121 defined therein for allowing flow of ink therethrough. Preferably, the through-holes 121 are arranged in a staggered disposition one line with another line and are different in size in order to provide an improved efficiency for the blades 12 and 12′ in stirring the ink.

In addition, one of the blades 12 and 12′, e.g. the blade 12′, as illustrated, is provided with a bottom lump 13 which has a large mass that the blades 12 and 12′ can swing to and fro within a movable ink cartridge 20 and thereby stir the ink, as a result of the reciprocating movement of the carriage during the printing process.

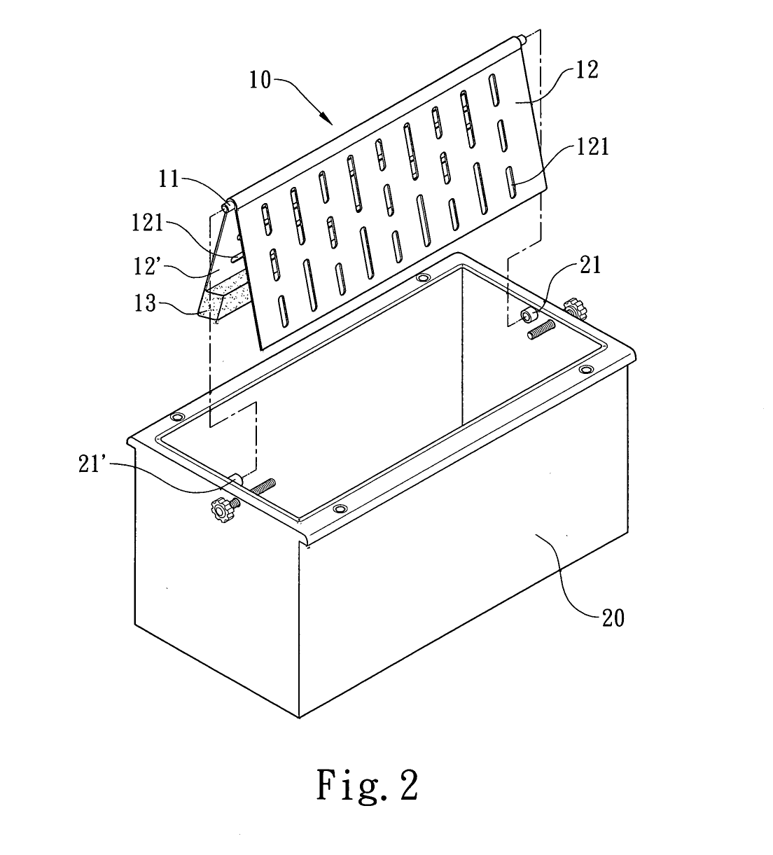

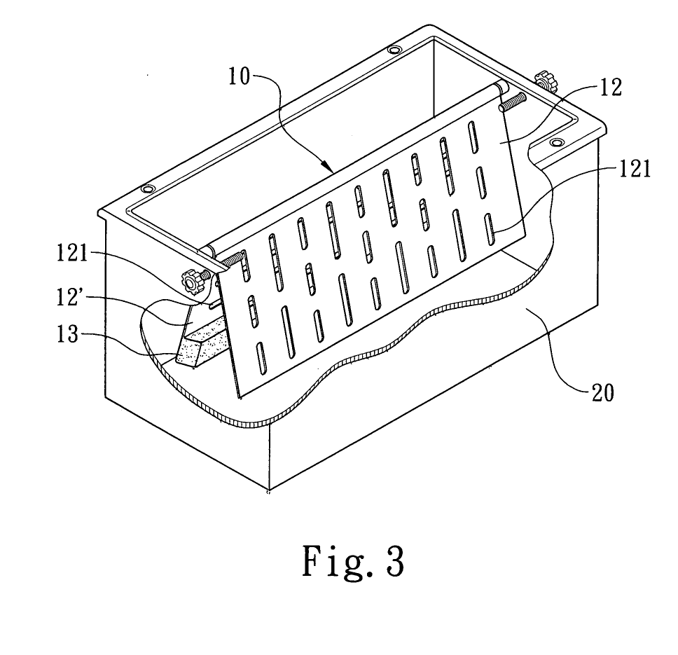

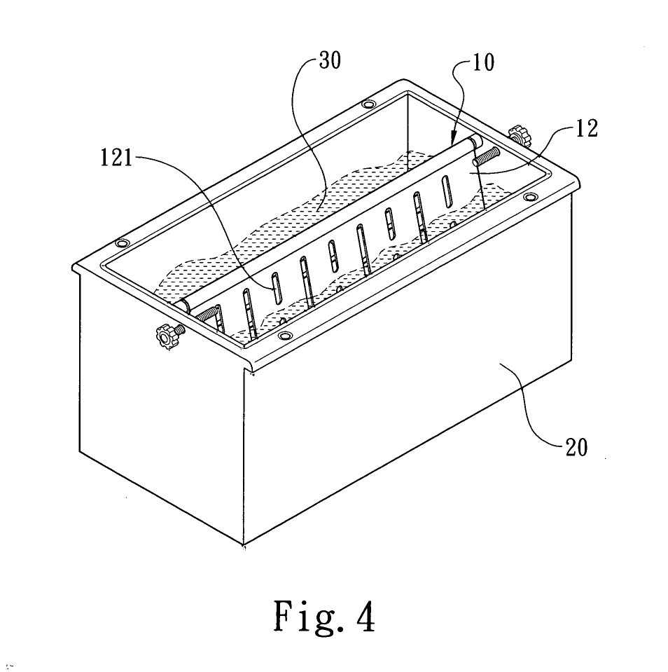

Referring to FIGS. 2 to 4, the spindle 10 is designed to be pivotally disposed within the ink cartridge 20, such as by pivotally connecting the spindle 10 to bores 21 and 21′ defined in opposite sidewalls of the same container 20. The reciprocating movement of the carriage during the printing process will force the blades 12 and 12′ to swing to and fro and stir the ink 30 in the cartridge 20.

Furthermore, the staggered disposition of the through-holes 121 in the blades 12 and 12′ may bring about eddy current in the ink 30, thus efficiently agitating the ink 30 and thoroughly eliminating the sediments which usually occur in ink cartridge 20 of the large ink-jet printer, particularly in white ink cartridge 20 due to the chemical property of such ink.

From the foregoing, it is apparent that the present invention is advantageous in that:
1. the present invention has blades which can swing to and fro within the ink cartridge as a result of the reciprocating movement of the carriage during the printing process, and eliminate sediments of white ink, thereby prolonging the life time of the ink cartridge and the print head;
2. the present invention has simplified components which can automatically and reliably stir the ink as a result of the reciprocating movement of the ink cartridge, thereby avoiding malfunctions happened in an electronic stirring device; and
3. the present invention provides blades formed with through-holes in a staggered arrangement, which can result in eddy current in the ink and provide an improved efficiency for the blades in stirring the ink.

Although embodiments together with structures and functions of the present invention have been described in detail, many modifications and variations may be made from the teachings disclosed hereinabove. Therefore, it should be understood by those skilled in the art that any modification and variation equivalent to the spirit of the present invention be regarded to fall into the scope coved by the appended claims.

What is claimed is:

1. An ink stirrer for a large ink-jet printer, said large ink-jet printer having a movable ink cartridge to hold ink therein, said ink stirrer comprising:
a spindle designed to be pivotally disposed within said ink cartridge; and
at least one blade extending downward from said spindle;
wherein one said blade is provided with a bottom lump having a large mass that said at least one blade may swing to and fro within said ink cartridge and thereby stir said ink as a result of the reciprocating movement of said ink cartridge.

2. The ink stirrer as claimed in claim 1, wherein said at least one blade has lines of through-holes defined therein for allowing flow of ink therethrough.

3. The ink stirrer as claimed in claim 2, wherein said through-holes are different in size.

4. The ink stirrer as claimed in claim 2, wherein said through-holes are arranged in a staggered disposition one line with another line.

5. The ink stirrer as claimed in claim 4, wherein said through-holes are different in size.

6. The ink stirrer as claimed in claim 1, wherein a pair of angularly spaced blades extends downward from said spindle, and wherein one of said blades is provided with said bottom lump.

7. The ink stirrer as claimed in claim 6, wherein each of said blades has lines of through-holes defined therein for allowing flow of ink therethrough.

8. The ink stirrer as claimed in claim 7, wherein said through-holes are arranged in a staggered disposition one line with another line.

9. The ink stirrer as claimed in claim 7, wherein said through-holes are different in size.

10. The ink stirrer as claimed in claim 1, wherein said spindle is formed integrally with said at least one blade.
